(19) United States
(12) Patent Application Publication
(10) Pub. No.: US 2011/0016515 A1
(43) Pub. Date: Jan. 20, 2011

(54) REALTIME MULTICHANNEL WEB PASSWORD RESET

(75) Inventors: GIRISH DHANAKSHIRUR, DELRAY BEACH, FL (US); PEEYUSH JAISWAL, BOCA RATON, FL (US)

Correspondence Address: LAW OFFICE OF JIM BOICE, 3839 BEE CAVE ROAD, SUITE 201, WEST LAKE HILLS, TX, 78746, US

(73) Assignee: INTERNATIONAL BUSINESS MACHINES CORPORATION, ARMONK, NY (US)

(21) Appl. No.: 12/505,208

(22) Filed: Jul. 17, 2009

(51) Int. Cl. G06F 7/04

(52) U.S. Cl. 726/6

(57) ABSTRACT

The need for realtime password resetting is providing by using a converged HTTP/SIP container. The container allows interaction between the different protocols of HTTP and SIP. When a user needs to reset a password that would normally require sending a new temporary password through the mail, the user can be appropriately authenticated and provided with a temporary key. After a temporary key is created and sent electronically to the user via the computer system which initiated the request, a telephony application calls the user. The user is prompted for authentication information and then enters the temporary key. The temporary key entered is compared with the temporary key created, and if matched, the user can reset the password in realtime.

### BACKGROUND

The technical field of the present invention relates in general to software security and more specifically to the field of web based password resetting.

Websites often offer subscription based services. The services offered typically require the user to login using a userid and password. Since some of these web sites are generally available to the public and can contain sensitive personal data, they may be vulnerable to attack from unauthorized personnel/hackers. In order to protect sensitive data from such attacks, some websites, for example, those owned by financial institutions (banks, brokerage firms, and the like) tighten security by enforcing strict password policies. These policies include, for example, setting the password to expire every sixty days, enforcing a minimum length of a password, and requiring a password to include a combination of alpha numeric and/or special characters. These strict password rules can often result in a situation where the subscriber might easily forget the password which can result in no access to the service. The subscriber then has to reset the password. Resetting passwords can take time, especially for websites owned by banks and other financial organizations, as such organizations are loath to risk sending temporary passwords to a public email provider such as Yahoo or Google mail. These organizations generally prefer to send a hard copy of the temporary password via the postal service, which may take days.

One way to avoid the postal service delay is to batch the request in a queue after the website has been authenticated with a challenge question/answer match. An Interactive Voice Response (IVR) application will pick requests from this queue later, make an outbound call to the customer, and deliver a unique code. The user will record this new unique code, revisit the website, and then enter that code which will now allow the user to reset or change the password. However, this solution is also inefficient, since the user has to wait indefinitely (might range from five minutes to an hour) to receive the call.

### SUMMARY

According to one embodiment of the present invention, a password for a secure on-line website can be reset in realtime using a computer system. A user requests resetting of the password which formerly allowed access to protected data on the website. A temporary user key is created and stored. The temporary user key is then electronically sent to the user. A telephonic call is made to a predetermined phone number belonging to the user with a telephony application. The user enters the temporary user key, as electronically sent to the user, as a response to the telephony application. The temporary user key as stored is compared with the temporary user key as entered by the user. If the temporary user key as stored matches the temporary user key as entered, the user is allowed to reset the password in realtime.

In addition, the temporary user key is stored in a computer database. Also, an expiration time for the temporary user key is stored. The user may be required to provide a predetermined user identification and answer at least one predetermined security question before the temporary key can be created. The computer system further includes a converged HTTP and SIP container. The user can respond to the telephony application either verbally or with the phone's keypad.

### BRIEF DESCRIPTION OF THE SEVERAL VIEWS OF THE DRAWINGS

The foregoing and other features and advantages of the present invention will be more fully understood from the following detailed description of illustrative embodiments, taken in conjunction with the accompanying drawings, in which:

FIG. 1 is an illustration of a representative scenario in which an embodiment of the present invention may be utilized; and

FIG. 2 is an illustration of converged container used in an embodiment of the present invention; and

FIG. 3 is a flowchart illustrating an embodiment of the present invention.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Today there are numerous web sites, which offer subscription based services. The services they offer require the user to login using a userid/password. The fact that these web sites are in public domain and may carry sensitive personal data makes them vulnerable to attacks from unauthorized users/hackers. In order to protect from such attacks, the websites, such as those for financial institutions, banks, brokerage firms, and the like, tighten the access security by enforcing strict password policies. These policies include, for example, setting the password to expire every sixty days, enforcing minimal length of the password with a combination of alpha numeric and/or special characters, and etc. These strict password rules may result in a situation where the subscriber might easily forget their password and end up with no access to the service. The subscriber then has to reset the password. Resetting the passwords takes time, especially for websites such as banks, financial institutions, and etc. since these institutions prefer to not take the risk by sending the temporary passwords to a public email provider, such as Yahoo and Google mail. They prefer to send the temporary passwords via mail through the U.S. Postal Service, which could take 3-5 business days.

There are some improvements over a postal service where the website, after authenticating with a challenge question/answer match, will batch the request in a queue. An Interactive Voice Response (IVR) application will later pick requests from this queue, make an outbound call to the customer, and deliver a unique code. The user will note this code and will have to revisit the website and enter that code, which will now allow the user to reset or change the password. However, this solution is also somewhat inefficient, since the user has to wait indefinitely (can range from five minutes to an hour) for that call.

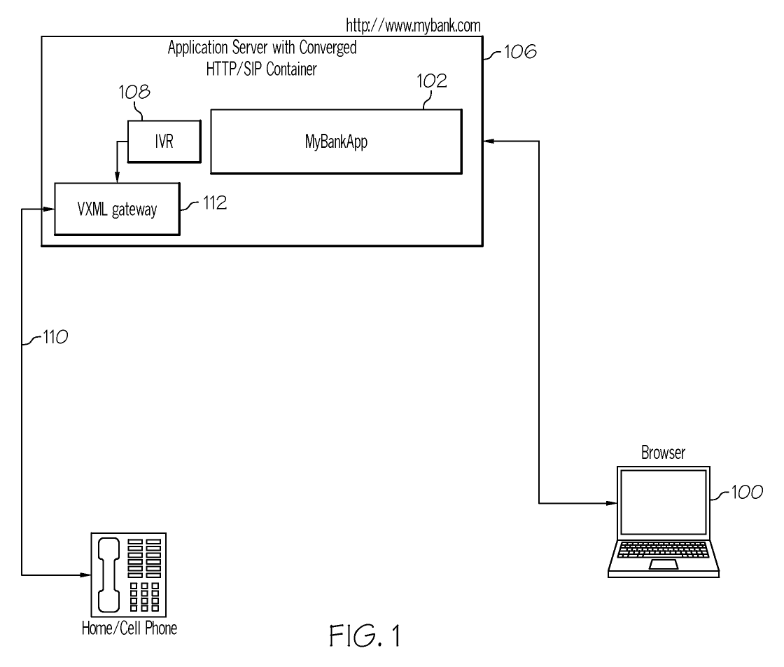

Referring to FIG. 1, an illustration of a representative scenario in which an embodiment of the present invention may be utilized is shown. Using a web browser, generally identified by reference numeral 100, a user visits a website, for example, www.mybank.com, to access a banking service such as MyBankApp 102. The website may host any number of applications running on an application server in a converged HTTP/SIP container 106. The container 106 converges or speaks several protocols, i.e., HTTP and SIP, and enables an application to traverse these different protocol interfaces. Here the application receives an HTTP request and sends out an SIP request.

Upon reaching the site, the user realizes that the password is lost, or expired. In order to resolve the need for a new password, the user is asked for a user ID, and a challenge question/answer exchange occurs. If the user ID and challenge question/answer exchange is correctly matched, a temporary key is created, stored and sent to the user for display on the browser 100.

A preferred phone number (e.g. home phone, work phone, cell phone) is obtained from a previously created user profile. An IVR application 108 will make an outbound call through a Voice Extensible Markup Language (VXML) gateway 112 to the preferred phone number over a telephone channel 110 and conduct a challenge question/answer exchange with the user. The user enters the temporary key (orally or via keypad). The gateway 112 will then terminate the call and notify MyBankApp 102 that the call was successfully established, terminated and the temporary key was captured.

MyBankApp 102 will now compare the received temporary key with the created temporary key and check for any time out variables, as will be subsequently described in more detail. If the time taken was more than timeout set, the session is destroyed and the user is redirected to the login page for the website. If the received temporary key matches the created temporary key, and the time is within the timeout value, MyBankApp 102 will direct the user to the appropriate page to reset their password. The user is now able to reset their password in realtime without the wait experienced in the prior art.

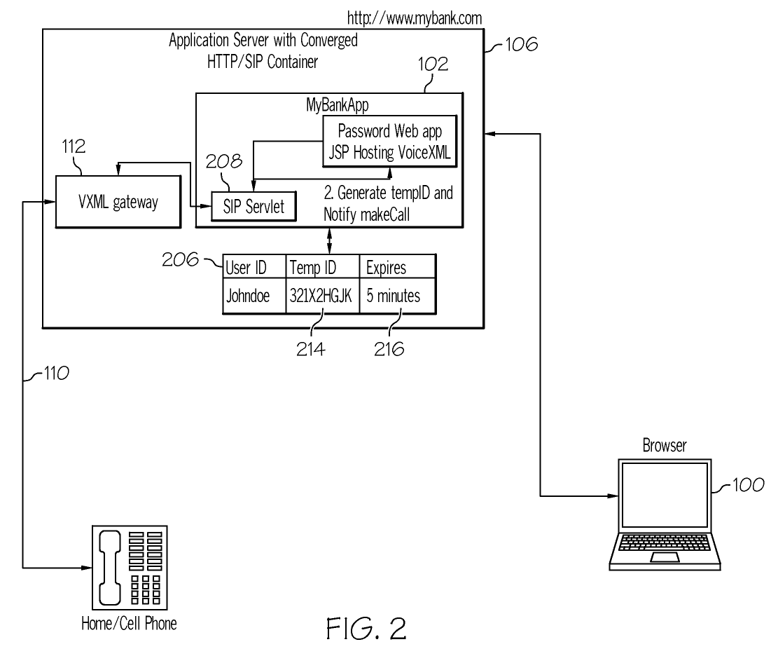

Referring now to FIG. 2, the process within the container 106 of FIG. 1 will be discussed in greater detail. The present invention takes advantage of Session Initiation Protocol (SIP), which is a telephony protocol on TCP/IP to establish and tear down phone calls, and HyperText Transfer Protocol (HTTP), the worldwide web protocol. A converged SIP/HTTP container, as is known in the art, is available from an enterprise application server such as, for example, IBM WebSphere Application Server, and BEA WebLogic SIP Server. The converged container allows a session in memory to simultaneously interact with two channels. Therefore, a web page and a telephone can communicate with the same session container on a back-end application server.

As previously described, a user has accessed a webpage, for example, www.mybank.com, for services through his/her account such as MyBankApp 102. Upon coming to the conclusion that the original password must be changed (forgotten), the user is directed to a password resetting web application 204 (a Java Server Page hosting VoiceXML). There, the user is required to provide an ID and answer security related questions. If the user is able to provide the right responses, the application 204 will create and store a temporary key 214 along with an expiration time 216 in a database table 206.

The expiration time 216 can be set to any predetermined amount of time (10 seconds, two minutes, five minutes, etc.) and is used to help keep out unauthorized users. Alternatively, the time can be set in reference to how long this, or other, users took to complete the required actions. The expiration time 216 can also be based on the phone (home phone, work phone, cell phone) called. Thereafter, the duration is updated automatically (only lowering the duration) based on how quick a user accomplishes the task for a particular type of phone. If most users perform the action quickly using home phones then that value gets decremented by ten second intervals, etc. The time interval will not exceed the default value to help avoid hacking. The application 204 forwards the request to make an outbound call to an SIP servlet 208 and to collect a key entered by the user.

The application 204 also queries a previously prepared user profile to get the user's preferred phone number (home, work, mobile). The temporary key 214 is stored with the phone number in a converged container session, and the SIP Servlet 208 gets notified to launch an IVR session with the user over the phone channel 110. The SIP Servlet 208 will notify a VoiceXML gateway 112. The gateway 112 makes an outbound call and plays a Text-To-Speech (TTS) program to let the user know of the interaction and to ask the user to confirm receipt of the key. The user reads the temporary key from the web notification (previously sent and displayed on the user's browser 100) and will either say or enter with the phone keypad the temporary key 214. The number of retries allowed if the responses are incorrect can also be controlled. For example, in order to maintain security, the home number will be allowed to retry (if an incorrect number is entered) three times, whereas, any other phone number will be allowed only one retry. The length of the temporary key 214 generated can be dependent upon how often the user has previously requested reset of the password. The more times the request (perhaps a hacker trying to intrude), the longer or more cryptic the key sequence generated will be. Also, a longer cryptic key is shown if the phone call being made is anything other than the user's home number. In general home numbers are considered to be safe and traceable.

After entering the temporary key 214, the call is terminated, and the captured temporary key is provided by the SIP Servlet 208 to the Web application 204. The web application 204 will compare the captured temporary key received with the temporary key 214 in the database table 206 and check for time out variables. If time taken was more than the timeout variable as set, the session is destroyed and the user is redirected to the login page. If the temp ID matches and time taken is within the timeout value, the user will be redirected to the password reset screen. The user may then reset their password.

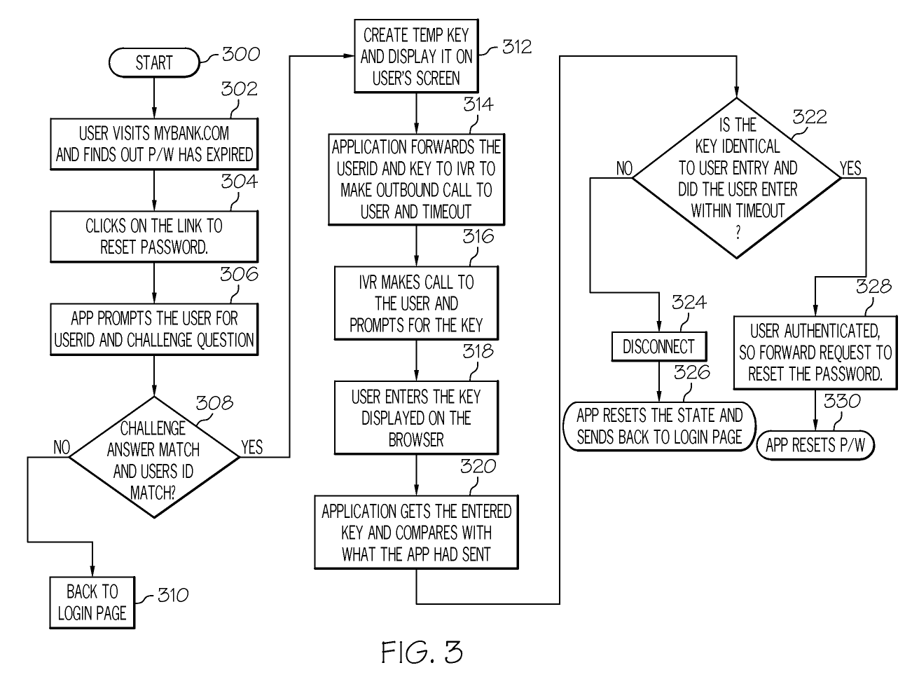

With reference now to FIG. 3, a flowchart of the present invention is shown. The invention starts at 300 and the user visits mybank.com at block 302. It is determined at block 302 that the user's password has expired or is forgotten. At block 304 the user clicks on a link to reset their password. At block 306, the application at the link prompts the user for a user ID and requests answer(s) to a challenge question(s).

At decision block 308 it is determined whether or not the user ID and challenge answers match the user's stored information. If the response is no, the user is returned to the login page at block 310. If the response to decision block 308 is yes, the invention proceeds to block 312 where a temporary key is created and sent to the user's browser.

The application forwards the user ID and temporary key to the IVR 108 to make an outbound call to the user and notes the timeout value at block 314. The IVR 108 calls the user and prompts for the temporary key at block 316. At block 318, the user enters the temporary key as displayed on his/her browser 100. The application 204 is provided with the user entered temporary key and compares it with the stored version at block 320.

At decision block 322, it is determined whether or not the entered key matches the created temporary key and if the time out value has not been exceeded. If the response is no, the present invention disconnects from the password reset page at block 324. The application resets the state and sends the user back to the login page at block 326. If the response to decision block 322 is yes, the user is authenticated and forwarded to reset the password at block 328. The user is then able to reset their password at block 330.

The present invention as shown and described herein has thus provided a resolution to a loss of a valid password for a secured transaction application on the internet. A user is afforded the benefit of being able to reset a password in realtime without having to wait for a password to be reset and sent through the mail.

What is claimed is:

1. A method for resetting a password in realtime for an online customer account related to a secure on-line website using a computer system, comprising the steps of:
requesting reset of the password, the password formerly allowing access to protected data on the website;
creating a temporary user key;
storing said temporary user key;
electronically sending said temporary user key to the user;
initiating a telephonic call to a predetermined phone number belonging to the user with a telephony application;
the user entering said temporary user key, as electronically sent to the user, as a response to said telephony application;
comparing said temporary user key as stored with said temporary user key as entered; and
if said temporary user key as stored matches said temporary user key as entered, allowing the user to reset the password, wherein the password is reset in realtime.

2. The method for resetting a password in realtime of claim 1, wherein said step of storing said temporary user key further comprises:
storing an expiration time for said temporary user key.

3. The method for resetting a password in realtime of claim 2, further comprising:
basing said expiration time on data obtained from how long previous reset actions have taken.

4. The method for resetting a password in realtime of claim 1, wherein said step of creating a temporary user key further comprises:
requiring the user to provide a predetermined user identification; and
requiring the user to answer at least one predetermined security question.

5. The method for resetting a password in realtime of claim 1, wherein the computer system further comprises a converged HTTP and SIP container.

6. The method for resetting a password in realtime of claim 1, wherein the step of the user entering said temporary user key, as electronically sent to the user, as a response to said telephony application further comprises allowing only a predetermined number of retries if an incorrect response is entered.

7. The method for resetting a password in realtime of claim 1, wherein the step of the user entering said temporary user key further comprises the steps of:
requiring the user to provide a predetermined user identification; and
requiring the user to answer at least one predetermined security question.

8. A computer system for resetting a password in realtime for an online customer account related to a secure on-line website, comprising:
means for requesting reset of the password, the password formerly allowing access to protected data on the website;
means for creating a temporary user key;
means for storing said temporary user key;
means for electronically sending said temporary user key to the user;
means for initiating a telephonic call to a predetermined phone number belonging to the user with a telephony application;
means for entering said temporary user key, as electronically sent to the user, by the user as a response to said telephony application;
means for comparing said temporary user key as stored with said temporary user key as entered; and
if said temporary user key as stored matches said temporary user key as entered, means for allowing the user to reset the password, wherein the password is reset in realtime.

9. The computer system for resetting a password in realtime of claim 8, wherein said step of storing said temporary user key further comprises:
means for storing an expiration time for said temporary user key.

10. The computer system for resetting a password in realtime of claim 9, further comprising:
means for basing said expiration time on data obtained from how long previous reset actions have taken.

11. The computer system for resetting a password in realtime of claim 8, wherein said means for creating a temporary user key further comprises:
means for requiring the user to provide a predetermined user identification; and
means for requiring the user to answer at least one predetermined security question.

12. The computer system for resetting a password in realtime of claim 8 further comprising a converged HTTP and SIP container.

13. The computer system for resetting a password in realtime of claim 8, wherein means for entering said temporary user key, as electronically sent to the user, as a response to said telephony application further comprises means for allowing only a predetermined number of retries if an incorrect response is entered.

14. The computer system for resetting a password in realtime of claim 8, wherein said means for entering said temporary user key further comprises:
means for requiring the user to provide a predetermined user identification; and means for requiring the user to answer at least one predetermined security question.

15. A computer program product embodied in a computer readable medium for resetting a password in realtime for an online customer account related to a secure on-line website, the computer program product comprising:
means for requesting reset of the password, the password formerly allowing access to protected data on the website;
means for creating a temporary user key;
means for storing said temporary user key;
means for electronically sending said temporary user key to the user;
means for initiating a telephonic call to a predetermined phone number belonging to the user with a telephony application;
means for entering said temporary user key, as electronically sent to the user, by the user as a response to said telephony application;
means for comparing said temporary user key as stored with said temporary user key as entered; and
if said temporary user key as stored matches said temporary user key as entered, means for allowing the user to reset the password, wherein the password is reset in realtime.

16. The computer program product for resetting a password in realtime of claim 15, wherein said means for storing said temporary user key further comprises:
means for storing an expiration time for said temporary user key.

17. The computer program product for resetting a password in realtime of claim 16, further comprising:
means for basing said expiration time on data obtained from how long previous reset actions have taken.

18. The computer program product for resetting a password in realtime of claim 15, wherein said means for creating a temporary user key further comprises:
means for requiring the user to provide a predetermined user identification; and
means for requiring the user to answer at least one predetermined security question.

19. The computer program product for resetting a password in realtime of claim 15 further comprising a converged HTTP and SIP container.

20. The computer program product for resetting a password in realtime of claim 15, wherein means for entering said temporary user key, as electronically sent to the user, as a response to said telephony application further comprises means for allowing only a predetermined number of retries if an incorrect response is entered.
